(19) United States
(12) Patent Application Publication
(10) Pub. No.: US 2005/0177851 A1
(43) Pub. Date: Aug. 11, 2005

(54) Mobile communication terminal recognition system and mobile communication terminal recognition method using the system

(76) Inventors: Yuji Murao, Tokyo (JP); Hirokazu Okita, Kanagawa-ken (JP); Fumihide Kojima, Kanagawa (JP); Masayuki Fujise, Kanagawa-ken (JP)

Correspondence Address: PEARNE & GORDON LLP, 1801 EAST 9TH STREET, SUITE 1200, CLEVELAND, OH, 44114-3108, US

(21) Appl. No.: 10/504,736

(22) PCT Filed: Feb. 18, 2003
(86) PCT No.: PCT/JP03/01690

(30) Foreign Application Priority Data
Feb. 18, 2002 (JP) 2002-40339

(51) Int. Cl. H04N 7/16; H04N 7/18; H04Q 7/20

(52) U.S. Cl. 725/75; 725/62; 455/425; 455/432.1; 455/440

(57) ABSTRACT

Herein disclosed are a mobile communication terminal recognizing system, a mobile communication terminal, a relay apparatus, a center apparatus, and a mobile communication terminal recognizing method, which enable a user to receive contents related to a cable television service, as well as are capable of easily identifying the service area where the user is located and accordingly communicating with the user regardless of whether or not the user moves into a service area other than the service area of the CATV station which the user has subscribed to. When a vehicle (5) moves into a service area of a CATV station (3, 4) other than the service area of the CATV station which the user has subscribed to and a CATV mobile terminal (6) receives contents from the ATV station (3, 4) by wireless, the CATV station (3, 4) is operated to store therein delivery history information indicative of a history of delivering the contents, and the CATV mobile terminal (6) is operated to store therein utilization history information indicative of a history of utilizing the contents. A subscriber station (2) is operated to collect and count the delivery history information and the utilization history information after transmitting an inquiry about the delivery history information and the utilization history information to the CATV station (3, 4) and the CATV mobile terminal (6) by way of multicast communication.

### TECHNICAL FIELD OF INVENTION

The present invention relates to a mobile communication terminal recognizing system capable of managing service history information indicative of a history of providing a cable television service even though a mobile communication terminal moves from one service area to another service area and receives the cable television service from two or more relay apparatuses installed in respective service areas, and more particularly to a mobile communication terminal, a relay apparatus, a center apparatus, and a mobile communication terminal recognizing method thereof.

### BACKGROUND ART

Up until now, there have been provided a wide variety of systems for providing a cable television service, hereinlater simply referred to as “CATV service”. The CATV service includes a television broadcasting service provided for a fringe and local area, and a service for a connection with a computer communication network, such as an internet.

The broadcasting programs of this CATV service include contents concerning a weather forecast, traffic information, a program of an event, music, a movie, and the like. A user subscribes to a cable television station, hereinlater simply referred to as “CATV station” in a service area where he or she lives, to have a dedicated connection line laid from the CATV station to his or her room. The user receives the contents through the dedicated connection line, and pays a fee charged in exchange for the contents to the CATV station.

The conventional CATV system, however, encounters a drawback that the user cannot receive the contents from the CATV station using a mobile communication terminal such as, for example, CATV mobile terminal mounted on a vehicle resulting from the fact that the user receives the contents through the dedicated connection line.

The conventional CATV system encounters another drawback that the user cannot receive any CATV service when the user moves into a service area of a CATV station other than the CATV station, to which the user has subscribed, resulting from the fact that the user subscribes to a CATV station in the fixed service area.

It is, accordingly, an object of the present invention to provide a system which makes it possible for a user to receive contents from the CATV station using a mobile communication terminal regardless of whether or not the user moves into a service area other than the service area of the CATV station to which the user has subscribed.

The present invention is made with a view to overcoming the above mentioned drawbacks and is directed to a mobile communication terminal recognizing system, a mobile communication terminal, a relay apparatus, a center apparatus, and a mobile communication terminal recognizing method, which enable a user to receive contents related to the cable television service as well as are capable of easily identifying the service area where the user is located and accordingly communicating with the user regardless of whether or not the user moves into a service area other than the service area of the CATV station to which the user has subscribed.

### DISCLOSURE OF THE INVENTION

According to one aspect of the present invention there is provided a mobile communication terminal recognizing system, comprising: a mobile communication terminal mounted on a movable object and capable of establishing a connection with a cable television service line by wireless; a plurality of relay apparatuses respectively installed in a plurality of service areas, and each of the relay apparatuses being operative to deliver contents concerning a cable television service to the mobile communication terminal moving within each of the service areas; a center apparatus for establishing a connection with the mobile communication terminal and the relay apparatuses to ensure that the mobile communication terminal moving within the service area receives the contents from one of the relay apparatuses, and in which the mobile communication terminal moving within a service area is operative to transmit request information and user information to the relay apparatus installed in the service area by wireless, the relay apparatus installed in the service area is operative to assign relay position identification information to the mobile communication terminal in response to the request information and user information, the mobile communication terminal is operative to transmit content request information to the relay apparatus determined in accordance with the relay position identification information by wireless upon receiving the relay position identification information, the relay apparatus is operative to deliver the contents to the mobile communication terminal and store therein delivery history information indicative of a history of delivering the contents in response to the content request information, the mobile communication terminal is operative to store therein utilization history information indicative of a history of utilizing the contents, the center apparatus is operative to inquire to the relay apparatuses about the delivery history information by wireless. Here, the communication is performed by way of IP communication using IPs respectively indicative of constituent devices forming par of CATV stations connected with one another through a network.

The relay apparatuses are operative to transmit the delivery history information to the center apparatus if stored therein, the center apparatus is operative to collect and count the delivery history information received from the relay apparatuses and inquire to each of the relay apparatuses about the user information of the mobile communication terminal having logged into in the service area of each of the relay apparatuses, and the mobile communication terminal is operative to transmit to the center apparatus the relay position identification information assigned thereto within the service area and the utilization history information stored therein in combination with the user information when the center apparatus inquires about the user information of the mobile communication terminal having logged into in the service area.

In accordance with the above construction, the mobile communication terminal is operative to receive contents delivered from the relay apparatus by wireless even through the movable object moves away from its service area into another service area of relay apparatus, which the user of the mobile communication terminal may not have subscribed to, and the mobile communication terminal is operative to store therein utilization history information indicative of a history of utilizing the contents, and the relay apparatus is operative to store therein delivery history information indicative of a history of delivering the contents. The center apparatus is operative to collect and count the delivery history information after inquiring the delivery history information to each of the relay apparatuses.

The mobile communication terminal recognizing system thus constructed makes it possible for the center apparatus to manage all of the delivery history information while enabling the mobile communication terminal to receive the contents even though the mobile communication terminal moves away from its service area into another service area of relay apparatus, which the user of the mobile communication terminal may not have subscribed to.

In addition, the center apparatus can communicate with the user of the mobile communication terminal, and obtain the utilization history information of a history of utilizing the contents delivered to the mobile communication terminal from the relay apparatus, which the mobile communication terminal has logged in, regardless of the relay position identification information (for example, local IP) assigned to the mobile communication terminal by each of the relay apparatuses because of the fact that the center apparatus is operative to inquire about the user information of the mobile communication terminal, which have logged into the relay apparatus, to each of the relay apparatuses by way of multicast communication, although the mobile communication terminal may move away from its service area into another service area of the relay terminal, which the user of the mobile communication terminal may have not subscribed to.

Further, in the mobile communication terminal recognizing system according to the present invention, the center apparatus may be operative to compare the collected and counted delivery history information with the utilization history information, and perform an accounting process on the basis of the result of the comparison when the mobile communication terminal transmits to the center apparatus the relay position identification information assigned thereto and the utilization history information stored therein in combination with the user information.

In accordance with the above construction, the center apparatus is operative to compare the collected and counted delivery history information with the utilization history information and perform an accounting process on the basis of the result of the comparison, thereby enabling the center apparatus to accurately charge the user for the utilization of the contents actually delivered by the relay apparatuses and the contents actually utilized by the mobile communication terminal, as well as accurately pay utilization fees to respective relay apparatuses.

Still further, the center apparatus is operative to compare the delivery history information received from the relay apparatuses with the utilization history information received from the mobile communication terminal, and when the utilization history information is not matched with the delivery history information, the center apparatus can inquire about the delivery history information and the utilization history information to each of the relay apparatuses, thereby making it possible for the center apparatus to make an appropriate response in the event that the accounting process is not sufficiently performed.

Further the more, in the mobile communication terminal recognizing system according to the present invention, the user information may be constituted by personal information stored in an IC (integrated circuit) card or a magnetic card.

In accordance with the above construction, the mobile communication terminal can log into a relay station in any service area using the user information (ID) stored in the IC card or the magnetic card without showing a log-in name, thereby preventing the CATV service from unauthorized use.

In addition, the center apparatus can collect information on the users who have logged into the relay apparatuses in respective service areas even though the mobile communication terminal should be modified or replaced because of the fact that the user information stored in the IC card will not change.

Further, in the mobile communication terminal recognizing system according to the present invention, the mobile communication terminal may be operative to communicate with each of the relay apparatuses using the relay position identification information assigned thereto by each of the relay apparatuses.

In accordance with the above construction, the center apparatus can obtain the relay position identification information assigned by the relay apparatus to the mobile communication terminal when the mobile communication terminal first moved into in the service area of the relay apparatus when the center apparatus inquires about the delivery history information to the relay apparatuses or about the utilization history information to the mobile communication terminal by way of multicast communication. This leads to the fact that the center apparatus can communicate with the mobile communication terminal using the same relay position identification information from then on, thereby reducing unnecessary packets caused by the multicast communication (because packets are delivered to all the terminals in the multicast communication).

According to another aspect of the present invention, there is provided a mobile communication terminal mounted on a movable object and capable of establishing a connection with a plurality of relay apparatuses each operative to deliver contents concerning a cable television service by wireless as well as communicating with a center apparatus operative to control the relay apparatuses, the mobile communication terminal comprising: first transmitting means for transmitting request information and user information to a relay apparatus installed in a service area by wireless; first receiving means for receiving relay position identification information assigned thereto from the relay apparatus by wireless; second transmitting means for transmitting content request information to the relay apparatus by wireless upon receiving the relay position identification information by the first receiving means; second receiving means for receiving the contents delivered from the relay apparatus; storage means for storing therein utilization history information indicative of a history of utilizing the contents received by the second receiving means, and third transmitting means for transmitting to the center apparatus the relay position identification information assigned thereto within the service area and the utilization history information stored therein in combination with the user information when the center apparatus inquires about the user information by way of multicast communication.

In accordance with the above construction, the mobile communication terminal is operative to receive contents delivered from the relay apparatus by wireless even through the movable object moves away from its service area into another service area of relay apparatus, which the user of the mobile communication terminal may not have subscribed to, and the mobile communication terminal is operative to store therein utilization history information indicative of a history of utilizing the contents, and the relay apparatus is operative to store therein delivery history information indicative of a history of delivering the contents. The center apparatus is operative to collect and count the delivery history information after inquiring the delivery history information to each of the relay apparatuses.

The mobile communication terminal thus constructed makes it possible for the center apparatus to manage all of the delivery history information while the mobile communication terminal can receive the contents even though the mobile communication terminal moves away from its service area into another service area of relay apparatus, which the user of the mobile communication terminal may not have subscribed to.

In addition, the center apparatus can communicate with the user of the mobile communication terminal, and obtain the utilization history information of a history of utilizing the contents delivered to the mobile communication terminal from the relay apparatus, which the mobile communication terminal has logged in, regardless of the relay position identification information (for example, local IP) assigned to the mobile communication terminal by each of the relay apparatuses because of the fact that the center apparatus is operative to inquire about the user information of the mobile communication terminal, which have logged into the relay apparatus, to each of the relay apparatuses by way of multicast communication, although the mobile communication terminal may move away from its service area into another service area of the relay terminal, which the user of the mobile communication terminal may have not subscribed to.

Further, in the mobile communication terminal according to the present invention, the user information may be constituted by personal information stored in an IC (integrated circuit) card or a magnetic card, and the mobile communication terminal may further comprise reading means for reading the user information stored in the IC card.

In accordance with the above construction, the mobile communication terminal can log into a relay station in any service area using the user information (ID) stored in the IC card or the magnetic card without showing a log-in name, thereby preventing the CATV service from unauthorized use.

In addition, the center apparatus can collect information on the users who have logged into the relay apparatuses in respective service areas even though the mobile communication terminal should be modified or replaced because of the fact that the user information stored in the IC card will not change.

Further, in the mobile communication terminal according to the present invention, the mobile communication terminal may be operative to communicate with each of the relay apparatuses using the relay position identification information assigned thereto by each of the relay apparatuses.

In accordance with the above construction, the center apparatus can obtain the relay position identification information assigned by the relay apparatus to the mobile communication terminal when the mobile communication terminal first moved into in the service area of the relay apparatus when the center apparatus inquires about the delivery history information to the relay apparatuses or about the utilization history information to the mobile communication terminal by way of multicast communication. This leads to the fact that the center apparatus can communicate with the mobile communication terminal using the same relay position identification information from then on, thereby reducing unnecessary packets caused by the multicast communication (because packets are delivered to all the terminals in the multicast communication).

According to a further aspect of the present invention, there is provided a relay apparatus installed in a service area, for delivering contents concerning a cable television service to a mobile communication terminal under the control of a center apparatus, the relay apparatus comprising: first receiving means for receiving request information and user information from the mobile communication terminal by wireless; first transmitting means for transmitting relay position identification information to be assigned to the mobile communication terminal to the mobile communication terminal in response to the request information and user information received by the first receiving means; second receiving means for receiving content request information from the mobile communication terminal by wireless; delivering means for delivering the contents to the mobile communication terminal in response to the content request information received by the second receiving means; storage means for storing therein delivery history information indicative of a history of delivering the contents; second transmitting means for transmitting the delivery history information stored in the storage means to the center apparatus when the center apparatus inquires about the delivery history information by way of multicast communication; and third transmitting means for transmitting to the center apparatus the user information of the mobile communication terminal having logged into in the service area when the center apparatus inquires about the user information of the mobile communication terminal having logged into in the service area, by way of multicast communication.

In accordance with the above construction, the mobile communication terminal is operative to receive contents delivered from the relay apparatus by wireless even through the movable object moves away from its service area into another service area of relay apparatus, which the user of the mobile communication terminal may not have subscribed to, and the mobile communication terminal is operative to store therein utilization history information indicative of a history of utilizing the contents, and the relay apparatus is operative to store therein delivery history information indicative of a history of delivering the contents. The center apparatus is operative to collect and count the delivery history information after inquiring the delivery history information to each of the relay apparatuses.

The relay apparatus thus constructed makes it possible for the center apparatus to manage all of the delivery history information while enabling the mobile communication terminal to receive the contents even though the mobile communication terminal moves away from its service area into another service area of relay apparatus, which the user of the mobile communication terminal may not have subscribed to.

In addition, the center apparatus can communicate with the user of the mobile communication terminal, and obtain the utilization history information of a history of utilizing the contents delivered to the mobile communication terminal from the relay apparatus, which the mobile communication terminal has logged in, regardless of the relay position identification information (for example, local IP) assigned to the mobile communication terminal by each of the relay apparatuses because of the fact that the center apparatus is operative to inquire about the user information of the mobile communication terminal, which have logged into the relay apparatus, to each of the relay apparatuses by way of multicast communication, although the mobile communication terminal may move away from its service area into another service area of the relay terminal, which the user of the mobile communication terminal may have not subscribed to.

Further, in the relay apparatus according to the present invention, the relay apparatus may be operative to communication with the mobile communication terminal using the relay position identification information assigned to the mobile communication terminal by the relay apparatus in the service area.

In accordance with the above construction, the center apparatus can obtain the relay position identification information assigned by the relay apparatus to the mobile communication terminal when the mobile communication terminal first moved into in the service area of the relay apparatus when the center apparatus inquires about the delivery history information to the relay apparatuses or about the utilization history information to the mobile communication terminal by way of multicast communication. This leads to the fact that the center apparatus can communicate with the mobile communication terminal using the same relay position identification information from then on, thereby reducing unnecessary packets caused by the multicast communication (because packets are delivered to all the terminals in the multicast communication).

According to a still further aspect of the present invention, there is provided a center apparatus for controlling a plurality of relay apparatuses respectively installed in a plurality of service areas, and each of the relay apparatuses being operative to deliver contents concerning a cable television service to a mobile communication terminal moving within each of the service areas, the center apparatus comprising: first transmitting means for inquiring to the relay apparatuses about a delivery history information indicative of a history of delivering the contents by way of multicast communication; first receiving means for receiving the deliver history information from the relay apparatuses; collecting and counting means for collecting and counting the delivery history information received from the relay apparatuses; second transmitting means for inquiring each of the relay apparatuses about user information of the mobile communication terminal having logged into in the service area of each of the relay apparatuses; and second receiving means for receiving relay position identification information assigned to the mobile communication terminal within the service area and utilization history information indicative of a history of utilizing the contents in combination with the user information from the mobile communication terminal.

In accordance with the above construction, the mobile communication terminal is operative to receive contents delivered from the relay apparatus by wireless even through the movable object moves away from its service area into another service area of relay apparatus, which the user of the mobile communication terminal may not have subscribed to, and the mobile communication terminal is operative to store therein utilization history information indicative of a history of utilizing the contents, and the relay apparatus is operative to store therein delivery history information indicative of a history of delivering the contents. The center apparatus is operative to collect and count the delivery history information after inquiring the delivery history information to each of the relay apparatuses.

The mobile communication terminal recognizing system thus constructed makes it possible for the center apparatus to manage all of the delivery history information while enabling the mobile communication terminal to receive the contents even though the mobile communication terminal moves away from its service area into another service area of relay apparatus, which the user of the mobile communication terminal may not have subscribed to.

In addition, the center apparatus can communicate with the user of the mobile communication terminal, and obtain the utilization history information of a history of utilizing the contents delivered to the mobile communication terminal from the relay apparatus, which the mobile communication terminal has logged in, regardless of the relay position identification information (for example, local IP) assigned to the mobile communication terminal by each of the relay apparatuses because of the fact that the center apparatus is operative to inquire about the user information of the mobile communication terminal, which have logged into the relay apparatus, to each of the relay apparatuses by way of multicast communication, although the mobile communication terminal may move away from its service area into another service area of the relay terminal, which the user of the mobile communication terminal may have not subscribed to.

Further, in the center apparatus according to the present invention, further comprising accounting means for comparing the collected and counted delivery history information with the utilization history information, and perform an accounting process on the basis of the result of the comparison when the mobile communication terminal transmits to the center apparatus the relay position identification information assigned thereto and the utilization history information in combination with the user information.

In accordance with the above construction, the center apparatus is operative to compare the collected and counted delivery history information with the utilization history information and perform an accounting process on the basis of the result of the comparison, thereby enabling the center apparatus to accurately charge the user for the utilization of the contents actually delivered by the relay apparatuses and the contents actually utilized by the mobile communication terminal, as well as accurately pay utilization fees to respective relay apparatuses.

In addition, the center apparatus is operative to compare the delivery history information received from the relay apparatuses with the utilization history information received from the mobile communication terminal, and when the utilization history information is not matched with the delivery history information, the center apparatus can inquire about the delivery history information and the utilization history information to each of the relay apparatuses, thereby making it possible for the center apparatus to make an appropriate response in the event that the accounting process is not sufficiently performed.

According to a yet further aspect of the present invention, there is provided a mobile communication terminal recognizing method of recognizing a mobile communication terminal moving within a service area in a system comprising a plurality of relay apparatuses respectively installed in a plurality of service areas, each of the relay apparatuses being operative to deliver contents concerning a cable television service to the mobile communication terminal moving within each of the service areas, a center apparatus for controlling the relay apparatuses to establish a connection with the mobile communication terminal and the relay apparatuses to ensure that the mobile communication terminal is recognized, the method comprising the steps of; (a) transmitting request information and user information to the relay apparatus installed in the service area by wireless; (b) transmitting relay position identification information assigned to the mobile communication terminal in response to the request information and user information, by the relay apparatus; (c) transmitting content request information to the relay apparatus determined in accordance with the relay position identification information by wireless upon receiving the relay position identification information, by the mobile communication terminal; (d) delivering the contents to the mobile communication terminal and store therein delivery history information indicative of a history of delivering the contents, by the relay apparatus in response to the content request information, by the relay apparatus; (e) storing therein utilization history information indicative of a history of utilizing the contents, by the mobile communication terminal; (f) inquiring to the relay apparatuses about the delivery history information by wireless, by the center apparatus; (g) transmitting the delivery history information to the center apparatus if stored therein, by the relay apparatuses; (h) collecting and counting the delivery history information and inquiring to each of the relay apparatuses about the user information of the mobile communication terminal having logged into in the service area of each of the relay apparatuses, by the center apparatus; and (i) transmitting from the mobile communication terminal to the center apparatus the relay position identification information assigned thereto within the service area and the utilization history information stored therein in combination with the user information when inquired about the user information of the mobile communication terminal having logged into in the service area.

In accordance with the above method, the mobile communication terminal is operative to receive contents delivered from the relay apparatus by wireless even through the movable object moves away from its service area into another service area of relay apparatus, which the user of the mobile communication terminal may not have subscribed to, and the mobile communication terminal is operative to store therein utilization history information indicative of a history of utilizing the contents, and the relay apparatus is operative to store therein delivery history information indicative of a history of delivering the contents. The center apparatus is operative to collect and count the delivery history information after inquiring the delivery history information to each of the relay apparatuses.

The mobile communication terminal recognizing system thus constructed makes it possible for the center apparatus to manage all of the delivery history information while enabling the mobile communication terminal to receive the contents even though the mobile communication terminal moves away from its service area into another service area of relay apparatus, which the user of the mobile communication terminal may not have subscribed to.

In addition, the center apparatus can communicate with the user of the mobile communication terminal, and obtain the utilization history information of a history of utilizing the contents delivered to the mobile communication terminal from the relay apparatus, which the mobile communication terminal has logged in, regardless of the relay position identification information (for example, local IP) assigned to the mobile communication terminal by each of the relay apparatuses because of the fact that the center apparatus is operative to inquire about the user information of the mobile communication terminal, which have logged into the relay apparatus, to each of the relay apparatuses by way of multicast communication, although the mobile communication terminal may move away from its service area into another service area of the relay terminal, which the user of the mobile communication terminal may have not subscribed to.

### BRIEF DESCRIPTION OF THE DRAWINGS

The features and advantage of a mobile communication terminal recognizing system and a mobile communication terminal recognizing method using the system according to the present invention will become apparent as the description proceeds when taken in conjunction with the accompanying drawings.

FIG. 1 is a schematic diagram showing preferred embodiments of a mobile communication terminal recognizing system, a mobile communication terminal, a relay apparatus, a center apparatus, and a mobile communication terminal recognizing method according to the present invention.

FIG. 2 is a block diagram showing preferred embodiments of a mobile communication terminal, a relay apparatus, and a center apparatus forming part of the mobile communication terminal recognizing system, the mobile communication terminal, the relay apparatus, the center apparatus, and the mobile communication terminal recognizing method according to the present invention.

FIG. 3 is a diagram showing a mobile communication terminal recognizing procedure of the preferred embodiment of the mobile communication terminal recognizing system, the mobile communication terminal, the relay apparatus, the center apparatus, and the mobile communication terminal recognizing method according to the present invention.

FIG. 4 is a diagram showing flows of information requests and response messages of the preferred embodiment of the mobile communication terminal recognizing system, the mobile communication terminal, the relay apparatus, the center apparatus, and the mobile communication terminal recognizing method according to the present invention.

### BEST MODE OF CARRYING OUT THE PRESENT INVENTION

The preferred embodiment of the present invention will be described hereinafter with reference to the drawings.

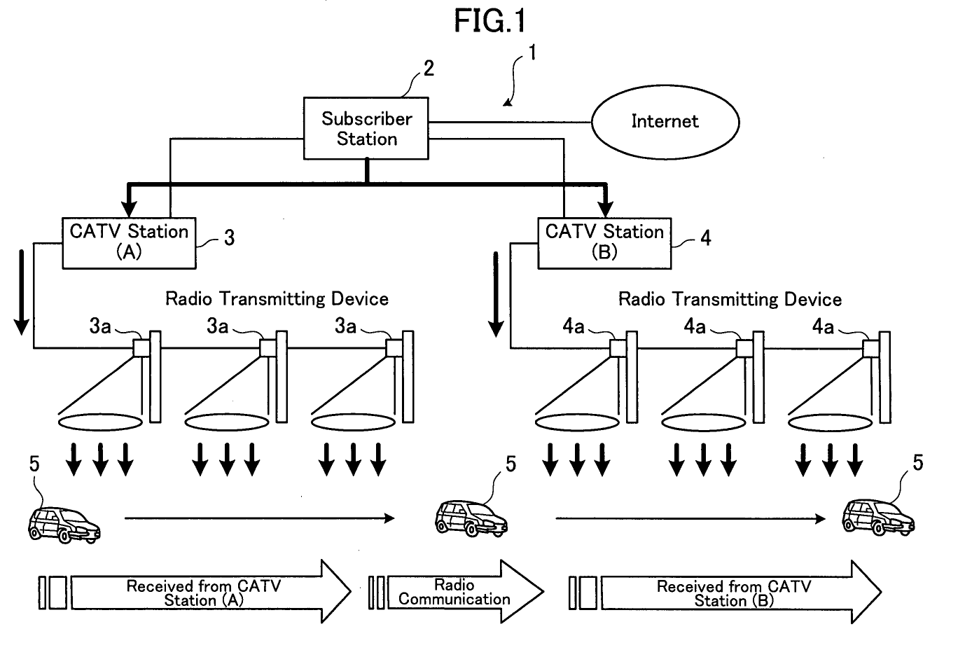

FIGS. 1 through 4 are diagrams showing preferred embodiments of a mobile communication terminal recognizing system, a mobile communication terminal, a relay apparatus, a center apparatus, and a mobile communication terminal recognizing method according to the present invention.

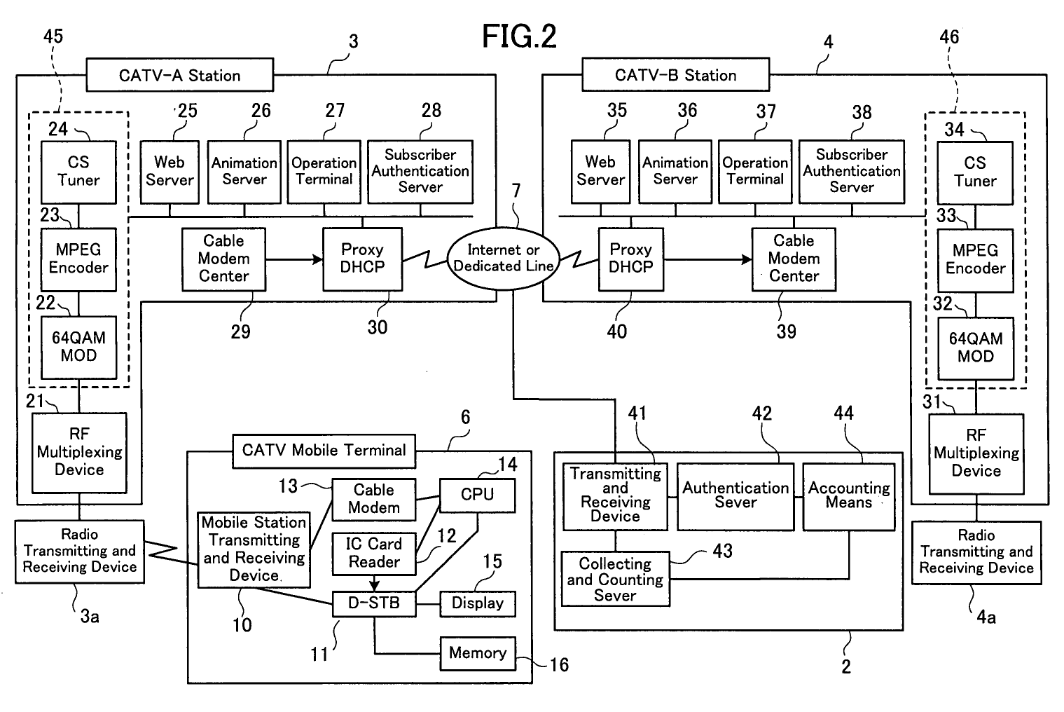

The construction will be described first. Referring to FIGS. 1 and 2, there is shown a mobile communication terminal recognizing system bearing a reference numeral 1. The mobile communication terminal recognizing system 1 comprises a subscriber station (center apparatus) 2, CATV stations 3 and 4 for delivering contents concerning a cable television service under the control of the subscriber station 2, a CATV mobile terminal (mobile communication terminal) 6 mounted on a vehicle (movable object) 5 and receiving the contents from the CATV stations 3 and 4.

In FIG. 1, there are shown only two CATV stations, namely CATV stations 3 and 4 for the purpose of simplifying the description and assisting in understanding about the whole operation. In reality, the mobile communication terminal recognizing system 1 comprises more than two CATV stations.

The CATV stations 3 and 4 are shown in FIG. 2 as respectively comprising CS (communication satellite) tuners 24 and 34 for receiving image data, MPEG encoders 23 and 33 for compressing the image data, 64 QAM modulators (QAM MOD) 22 and 32 for modulating the image data compressed by the MPEG encoders 23 and 33 into data of predetermined formats to be delivered through CATV lines. The CS tuners 24 and 34, the MPEG encoders 23 and 33, and the 64 QAM modulators 22 and 32 respectively constitute CATV image transmitting devices 45 and 46.

Here, the CS tuners 24 and 34 may transfer to the MPEG encoders 23 and 33 the image data stored in a video tape, optical disc, or the like.

As shown in FIG. 1, the CATV stations 3 and 4 further comprises a plurality of radio transmitting and receiving devices 3a and 4a installed in respective service areas as communication lines, thereby making it possible for the CATV stations 3 and 4 to deliver the contents (music, a movie, news, a weather forecast, a variety program, and the like) within their respective service areas. Preferably, as the radio transmitting and receiving device should be used a millimeter wave-band radio on fiber (ROF) signal transmission system.

The CATV mobile terminal 6 comprises a mobile station transmitting and receiving device 10, a digital set top box (D-STB) 11, an IC card reader (reading and writing means) 12, a cable modem 13, a CPU 14, a display 15, and a memory 16.

The mobile station transmitting and receiving device 10 is designed to transmit and receive a signal with each of the radio transmitting and receiving devices 3a and 4a when entered into the service area of each of the CATV stations 3 and 4 to ensure that the CATV mobile terminal 6 communicates with each of the CATV stations 3 and 4 by wireless. The D-STB 11 is designed to process the signals received and transmitted with each of the radio transmitting and receiving devices 3a and 4a to perform bidirectional communications.

The IC card reader 12 is designed to have an IC card inserted thereinto, and read out, as user information, an ID, an accounting record, a bank account number, an address, and the like from the IC card. The user information is transmitted by the D-STB 11 to the radio transmitting and receiving device 3a or 4a through the mobile station transmitting and receiving device 10.

The cable modem 13 is adapted to demodulate the contents data contained in the signal received by the mobile station transmitting and receiving device 10. The contents thus demodulated are reproduced by the display 15.

The CPU 14 constituted by, for example, a notebook computer, is adapted to control the whole operation of the CATV mobile terminal 6 as well as to provide various IP services. The CPU 14 is operative to control, for example, the IC card reader 12 to have the IC card reader 12 read out from the IC card the user information to be outputted therethrough.

The D-STB 11 is operative to extract a digital signal element of a predetermined channel from the received digital signal, convert the digital signal element thus extracted into an information signal such as for example an image signal, judge whether or not the information signal can be delivered, and generate accounting information on the basis of the user information read out from the IC card.

In addition, the CPU 14 is operative to control the mobile station transmitting and receiving device 10 and the D-STB 11 to have the mobile station transmitting and receiving device 10 transmit request information and the user information read out by the IC card reader 12 to the CATV station 3 or the CATV station 4 through the D-STB 11 when the CATV mobile terminal 6 is moved into the service area of the CATV station 3 or the CATV station 4. The CPU 14, the mobile station transmitting and receiving device 10, and the D-STB 11 collectively constitute first transmitting means.

Further, the CPU 14 is operative to control the memory 16 to have the memory 16 store therein CATV station identification information (a local IP as a relay position identification information assigned by the CATV station 3 or the CATV station 4) received from the CATV station 3 or the CATV station 4 by the mobile station transmitting and receiving device 10 through the D-STB 11. The CPU 14, the mobile station transmitting and receiving device 10, and the D-STB 11 collectively constitute first receiving means.

Still further, the CPU 14 is operative to control the mobile station transmitting and receiving device 10 and the D-STB 11 to have the mobile station transmitting and receiving device 10 transmit to the CATV station 3 or the CATV station 4, which has assigned the local ID to the CATV mobile terminal 6, content request information, i.e., a request signal for the contents of, for example, the music, the movie, the news, or the like, through the D-STB 11 after the local IP is received by the mobile station transmitting and receiving device 10. The CPU 14, the mobile station transmitting and receiving device 10, and the D-STB 11 collectively constitute second transmitting means.

Further the more, the CPU 14 is operative to control the display 15 to have the display 15 output the content when the contents delivered from the CATV station 3 or the CATV station 4 is inputted to the D-STB 11 through the mobile station transmitting and receiving device 10. The CPU 14, the mobile station transmitting and receiving device 10, and the D-STB 11 collectively constitute second receiving means. The memory 16 is adapted to store therein utilization history information indicative of a history of utilizing the contents received from the CATV station 3 or the CATV station 4. The memory 16 constitutes storage means.

Further the more, the CPU 14 is operative to control the mobile station transmitting and receiving device 10 to have the mobile station transmitting and receiving device 10 transmit to the subscriber station 2 the local IP assigned to the CATV mobile terminal 6 within the service area and the utilization history information stored in the memory 16 in combination with the user information and information on the CATV station, from which the contents are currently received, when the subscriber station 2 inquires about the user information by way of multicast communication through the CATV station 3 and CATV station 4. The CPU 14 and the mobile station transmitting and receiving device 10 collectively constitute third transmitting means.

The CATV stations 3 and 4 respectively comprises radio frequency (RF) multiplexing devices 21 and 31, 64 QAM modulators (QAM MOD) 22 and 32, MPEG encoders 23 and 33, CS tuners 24 and 34 (CATV image transmitting devices 45 and 46), Web servers 25 and 35, animation servers 26 and 36, operation terminals 27 and 37, subscriber authentication servers 28 and 38, cable modem centers 29 and 39, and proxy DHCP (Dynamic Host Configuration Protocol) servers 30 and 40.

The radio frequency (RF) multiplexing devices 21 and 31 are adapted to establish radio communications with the CATV mobile terminal 6 respectively through the radio transmitting and receiving devices 3a and 4a. The MPEG encoders 23 and 33 are adapted to convert the image data respectively inputted from the CS tuners 24 and 34 into MPEG image data. The 64 QAM modulators (QAM MOD) 22 and 32 are adapted to modulate the MPEG image data with respect to the amplitude and phase. The MPEG encoders 23 and 33 are capable of receiving signal data from BS (Broadcasting Satellite) through the CS tuners 24 and 34.

The Web servers 25 and 35 are capable of connecting with an internet and adapted to deliver and obtain various contents through the internet. The animation servers 26 and 36 are adapted to deliver the contents of animation data such as for example a movie, music, a weather forecast, and news. The operation terminals 27 and 37 are adapted to permit a user to operate various functions of the CATV stations 3 and 4.

The subscriber authentication servers 28 and 38 are adapted to store therein various information on users who have subscribed to the CATV stations 3 and 4. The information on the users includes IDs. The subscriber authentication servers 28 and 38 are operative to judge whether or not the user is authentic by comparing the ID stored therein with the user information (ID) received from the CATV mobile terminal 6. The subscriber authentication servers 28 and 38 are operative to provide to the user a service such as for example a service of delivering contents when it is judged that the user is authentic as a result of the comparison. The subscriber authentication servers 28 and 38, on the other hand, are operative to inquire about the user to the other CATV stations when it is judged that the user is not authentic. The subscriber authentication servers 28 and 38 are operative to assign a local ID to the user and provide the service to the user when the user is judged to be authentic as a result of the inquiry.

Each of the proxy DHCP servers 30 and 40 is operative to dynamically assign an IP to a user terminal when the user terminal is activated. Each of the proxy DHCP servers 30 and 40, on the other hand, is operative to invalidate the IP when the user terminal is terminated. In addition, each of the proxy DHCP servers 30 and 40 is operative to assign a local IP to the CATV mobile terminal 6 in response to the request information for the local IP from the CATV mobile terminal 6.

The cable modem centers 29 and 39 are adapted to perform data communication such as an internet access with the CATV mobile terminal 6, user's fixed terminal device, the CATV stations, and the like through the CATV line, and deliver the contents to the CATV mobile terminal 6 and the user's fixed terminal device by way of IP communication at high speed. The user's terminals are required to be different from facilities of the CATV stations in network segments so as to enhance the security. The cable modem centers 29 and 39 serve to make secure the connection between the user's terminal and the CATV stations.

In the present embodiment, the radio transmitting and receiving device constitutes first receiving means for receiving the local IP request information and user information from the CATV mobile terminal 6 by wireless.

Each of the proxy DHCP servers 30 and 40 is operative to assign a local IP to the CATV mobile terminal 6 when each of the radio transmitting and receiving devices 3a and 4a receives the local IP request information and the user information from the CATV mobile terminal 6, and each of the radio transmitting and receiving devices 3a and 4a is operative to transmit the local IP to the CATV mobile terminal 6. The radio transmitting and receiving device and the proxy DHCP server constitute first transmitting means.

Each of the radio transmitting and receiving devices 3a and 4a constitutes second receiving means for receiving content request information from the CATV mobile terminal 6 by wireless.

The animation servers 26 and 36 and the Web servers 25 and 35 are operative to deliver the contents to the CATV mobile terminal 6 in response to the content request information. The radio transmitting and receiving device, the animation server, and the Web server constitute delivering means.

The animation servers 26 and 36 and the Web servers 25 and 35 are designed to store therein delivery history information indicative of a history of delivering the contents. The animation server and the Web server constitute storage means.

The proxy DHCP servers 30 and 40 are connected with the subscriber station 2 through the internet, the leased line or the dedicated line. The proxy DHCP servers 30 and 40 are operative to transmit the delivery history information stored in the animation servers 26 and 36 and the Web servers 25 and 35 to the subscriber station 2 when the subscriber station 2 inquires about the delivery history information by way of multicast communication. The proxy DHCP server constitutes second transmitting means.

The subscriber authentication servers 28 and 38 are operative to judge whether or not the user is authentic by comparing the user information stored therein with the user information received from the CATV mobile terminal 6. When it is judged that the user is not authentic, the subscriber authentication servers 28 and 38 are operative to inquire about the user to the subscriber station 2 by way of IP communication. Each of the subscriber authentication servers 28 and 38 is operative to permit the CATV mobile terminal 6 to receive the CATV service when the user is judged by the subscriber station 2 to be authentic as a result of the inquiry. When the subscriber station 2 inquires about the user information of the CATV mobile terminal 6 having logged into in the service area of each of the CATV stations 3 and 4, by way of multicast communication, each of the subscriber authentication servers 28 and 38 and each of the proxy DHCP servers 30 and 40 may be operative to transmit to the subscriber station 2 the user information of the CATV mobile terminal 6 having logged into in the service area. The subscriber authentication server and the proxy DHCP server constitute third transmitting means.

Further, the subscriber authentication servers 28 and 38 are operative to communicate with the CATV mobile terminal 6 using the local IP assigned by the CATV stations 3 and 4 installed in their respective service areas at the first communication.

The subscriber station 2 comprises a transmitting and receiving device 41, an authentication server 42, a collecting and counting server 43, and accounting means 44.

The transmitting and receiving device 41 is connected with the CATV stations 3 and 4 through the internet, the leased line, or the dedicated line, and adapted to inquire about the delivery history information indicative of a history of delivering the contents to the CATV mobile terminal 6 through the CATV stations 3 and 4 by means of IP communication. The transmitting and receiving device 41 is adapted to receive the delivery history information from the CATV stations 3 and 4. In the present embodiment, the transmitting and receiving device 41 constitutes first transmitting means and first receiving means.

The collecting and counting server 43 is adapted to collect and count the delivery history information received from the CATV stations 3 and 4 through the transmitting and receiving device 41, and the utilization history information received from the CATV stations 3 and 4 through the transmitting and receiving device 41. The collecting and counting server 43 constitute collecting and counting means.

The authentication server 42 is adapted to store therein various information on users who have subscribed to the CATV stations 3 and 4. The information on the users includes IDs. The authentication server 42 is operative to judge whether or not the user is authentic by comparing the ID stored therein with the user information (ID) received from the CATV mobile terminal 6.

The authentication server 42 is adapted to inquire to the CATV stations 3 and 4 about the user information of the CATV mobile terminal 6 having logged into in their respective service areas of the CATV stations 3 and 4, by way of multicast communication. The transmitting and receiving device 41 and the authentication server 42 constitute second transmitting means.

The authentication server 42 is operative to receive local IP currently assigned to the CATV mobile terminal 6 within the service area in combination with the user information and information on the CATV station, from which the contents are currently received, from the CATV mobile terminal 6, and the collecting and counting server 43 is operative to receive the utilization history information from the CATV mobile terminal 6 when the transmitting and receiving device 41 receives a response to the inquiry from the CATV mobile terminal 6. The transmitting and receiving device 41, the authentication server 42 and the collecting and counting server 43 collectively constitute second receiving means.

The accounting means 44 is adapted to compare the delivery history information collected and counted by the collecting and counting server 43 with the utilization history information of the CATV mobile terminal 6, and perform an accounting process for the delivery history information and the utilization history information on the basis of the result of the comparison. The accounting means 44 constitutes accounting means. The accounting process is performed for the delivery history information of each of the subscriber station and the CATV stations. Firstly, the subscriber station charges the user for the utilization of the contents on the basis of the delivery history information of all of the CATV stations. Then, the subscriber station pays utilization fees to respective CATV stations.

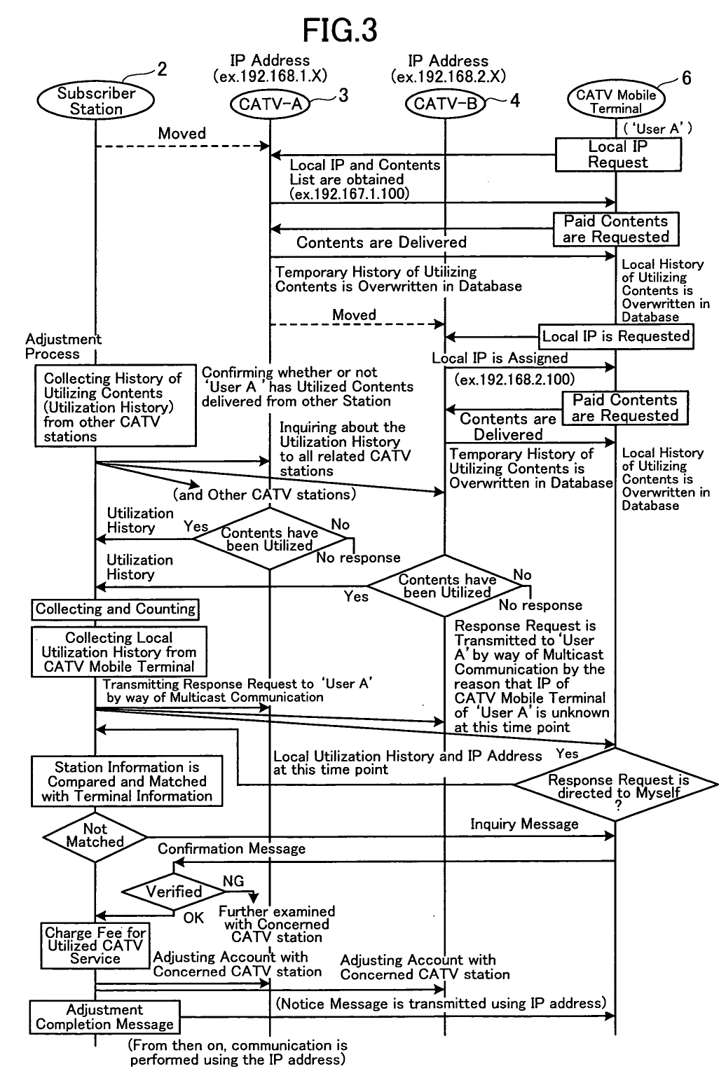

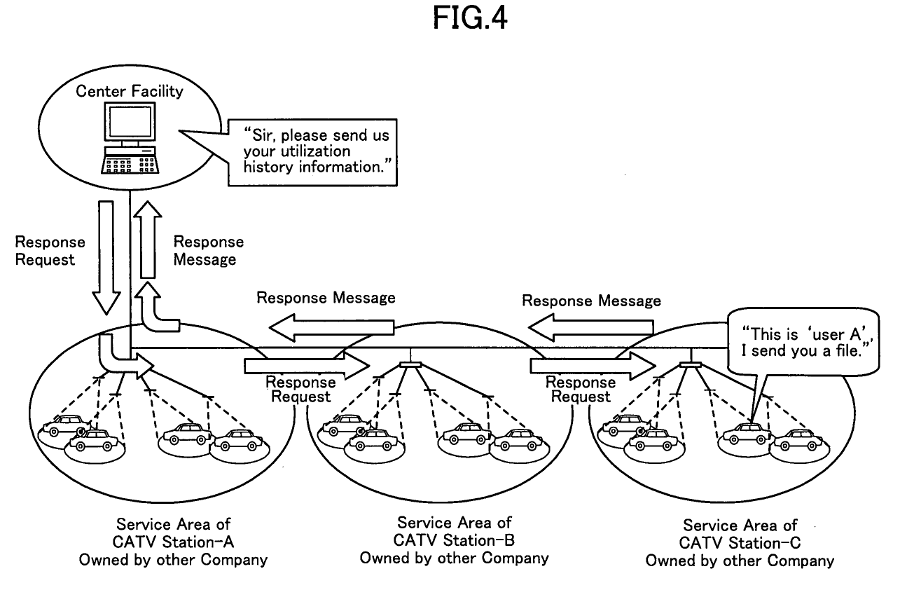

The procedure of the mobile communication terminal recognizing method will be described hereinafter with reference to FIGS. 3 and 4.

As shown in FIG. 3, a vehicle 5 having a CATV mobile terminal 6 mounted thereon moves into a service area of a CATV station 3 (hereinlater referred to as “CATV-A”). The CATV mobile terminal 6 is operated to transmit request information for a local IP in combination with user information read out by the IC card reader 12 from an IC card to the CATV-A.

The CATV-A is operated to judge whether or not the user is authentic by comparing the user identification information stored in the subscriber authentication server 28 with the user information received from the CATV mobile terminal 6. The CATV-A is operated to judge that the user is not authentic, i.e., the user has not subscribed to the CATV-A when the user information stored in the subscriber authentication server 28 is not matched with the user information received from the CATV mobile terminal 6, and the CATV-A is operated to inquire to the subscriber station 2 about the user. The subscriber station 2 is operated to judge whether or not the user is authentic by comparing the user information stored therein with the user information of the CATV mobile terminal 6. When the user information stored in the subscriber station 2 is matched with the user information of the CATV mobile terminal 6, the user is judged to be authentic and the CATV-A is operated to assign a local IP (e.g., 192.167.1.100) to the CATV mobile terminal 6, and start providing the CATV service to the user.

The CATV mobile terminal 6 is then operated to transmit content request information for paid contents of, for example, a movie to the CATV-A. The CATV-A is operated to deliver the contents of the movie to the CATV mobile terminal 6, and store delivery history information indicative of a history of delivered contents into the animation server 26, which serves as a database (DB).

When the vehicle 5 having the CATV mobile terminal 6 mounted thereon further moves into a service area of a CATV station 4 (hereinlater referred to as “CATV-B”), the CATV mobile terminal 6 is operated to transmit request information for a local IP in combination with user information read out by the IC card reader 12 from an IC card to the CATV-B.

The CATV-B is operated to judge whether or not the user is authentic by comparing the user identification information stored in the subscriber authentication server 38 with the user information received from the CATV mobile terminal 6. The CATV-B is operated to judge that the user is not authentic, i.e., the user has not subscribed to the CATV-B when the user information stored in the subscriber authentication server 28 is not matched with the user information received from the CATV mobile terminal 6, and the CATV-B is operated to assign a local IP (e.g., 192.168.2.100) to the CATV mobile terminal 6.

The CATV mobile terminal 6 is then operated to transmit content request information for paid contents of, for example, news to the CATV-B. The CATV-B is operated to deliver the contents of the news to the CATV mobile terminal 6, and store delivery history information indicative of a history of delivered contents into the animation server 36, which serves as a database (DB).

In order to adjust an account, the subscriber station 2 is operated to inquire about the delivery history information to the CATV-A, the CATV-B, and other CATV stations installed in respective service areas through the transmitting and receiving device 41 by way of IP communication.

The CATV-A, the CATV-B, and other CATV stations are operated to respectively transmit the delivery history information to the subscriber station 2 if the delivery history information is stored in the animation servers 26 and 36, and the like. The CATV-A, the CATV-B, and other CATV stations, on the other hand, are not operated to respond to the subscriber station 2 if no delivery history information is stored therein.

In the subscriber station 2, the collecting and counting server 43 is operated to collect and count the delivery history information. The transmitting and receiving device 41 is then operated to transmit a response request to the CATV mobile terminal 6 through the CATV-A, the CATV-B, and other CATV stations by way of multicast communication. The response request has a log-in user as key information, and includes a message that “Sir, (‘user A’ in the present case), please send us your utilization history information” as shown in FIG. 4. When the CATV mobile terminal 6 has logged into in the service area of one of the CATV stations, the CATV mobile terminal 6 is operated to transmit to the subscriber station 2 a response signal. The response signal includes a response message that “This is XX (‘user A’ in this case). I send you a file (utilization history information)” as shown in FIG. 4. The CATV mobile terminal 6 is operated to transmit the local ID currently assigned thereto within the service area, the utilization history information, and identification information of the CATV station which the CATV mobile terminal 6 has logged in to, if required, in combination with the user information (ID) stored in the IC card to the subscriber station 2.

In the subscriber station 2, the utilization history information is then collected and counted by the collecting and counting server 43, and compared with the delivery history information. When the utilization history information is matched with the delivery history information, the accounting process is performed for the utilized contents delivered through the CATV-A station, the CATV-B station, and the other CATV stations in order to adjust accounts of the CATV-A station, the CATV-B station, and the other CATV stations.

When, on the other hand, the utilization history information is not matched with the delivery history information, the subscriber station 2 is operated to transmit an inquiry message to the CATV mobile terminal 6. When the utilization history information is verified by a confirmation message transmitted by the CATV mobile terminal 6 in response to the inquiry message, the accounting process is performed for the utilized contents delivered through the CATV-A station, the CATV-B station, and the other CATV stations. When, on the other hand, the utilization history information is not verified by the confirmation message, the subscriber station 2 is further operated to examine the unmatched utilization history information separately with the concerned CATV station.

When the adjustment process is completed, the subscriber station 2 is operated to transmit an adjustment completion message to the CATV mobile terminal 6 using the local IP address assigned thereto by the CATV station when the CATV mobile terminal 6 moved into the service area of the CATV station. From then on, the CATV mobile terminal 6 is operated to communicate with the subscriber station 2 using the local IP address through the CATV station.

As will be seen from the foregoing description, it is to be understood that the present embodiment of the CATV mobile terminal 6 is operative to receive contents delivered from the CATV station 3 or 4 by wireless even through the vehicle 5 moves away from its service area into another service area of CATV station 3 or 4, which the user of the CATV mobile terminal 6 may not have subscribed to, and the CATV mobile terminal 6 is operative to store therein utilization history information indicative of a history of utilizing the contents, and the CATV station 3 or 4 is operative to store therein delivery history information indicative of a history of delivering the contents. The subscriber station 2 is also operative to collect and count the delivery history information after inquiring the delivery history information to each of the CATV stations 3 and 4. The mobile communication terminal recognizing system 1 thus constructed makes it possible for the subscriber station 2 to manage all of the delivery history information while enabling the CATV mobile terminal 6 to receive the contents even though the CATV mobile terminal 6 moves away from its service area into another service area of CATV station 3 or 4, which the user of the CATV mobile terminal 6 may not have subscribed to.

In addition, the subscriber station 2 can communicate with the user of the particular CATV mobile terminal 6, and obtain the utilization history information of a history of utilizing the contents delivered to the CATV mobile terminal 6 from the CATV station 3 or 4, which the CATV mobile terminal 6 has logged in, regardless of the local IP assigned to the CATV mobile terminal 6 by the CATV station 3 or 4 because of the fact that the subscriber station 2 is operative to inquire about the user information (ID) of the CATV mobile terminal 6, which have logged into the CATV station 3 or 4, to the CATV stations 3 and 4 by way of multicast communication, although the CATV mobile terminal may move away from its service area into another service area of the CATV station 3 or 4, which the user of the CATV mobile terminal 6 may not have subscribed to.

Further, the subscriber station 2 is operative to compare the collected and counted delivery history information with the utilization history information and perform an accounting process on the basis of the result of the comparison when the CATV mobile terminal 6 transmits the local IP assigned thereto by the CATV station 3 or 4, the utilization history information, and the user information to the subscriber station 2, thereby enabling the subscriber station 2 to accurately charge the user for the utilization of the contents actually delivered by the CATV stations 3 and 4 and the contents actually utilized by the CATV mobile terminal 6, as well as accurately pay utilization fees to respective CATV stations 3 and 4.

Still further, the subscriber station 2 is operative to compare the delivery history information received from the CATV stations 3 and 4 with the utilization history information received from the CATV mobile terminal 6. When the utilization history information is not matched with the delivery history information, the subscriber station 2 can inquire about the delivery history information and the utilization history information to each of the CATV stations 3 and 4, thereby making it possible for the subscriber station 2 to make an appropriate response in the event that the accounting process is not sufficiently performed.

In the present embodiment, as the user information is used personal information stored in an IC card. This means that the CATV mobile terminal 6 can log into a CATV station in any service area using the user information (ID) stored in the IC card without showing a log-name, thereby preventing the CATV service from unauthorized use. The user information may be stored in a magnetic card.

In addition, the subscriber station 2 can still collect information on the users who have logged into the CATV stations in respective service areas even though the CATV mobile terminal 6 should be modified or replaced because of the fact that the user information stored in the IC card will not change. When the user of the CATV mobile terminal 6 is changed, the user information stored in the CATV mobile terminal 6 until then will be transferred to the subscriber station 2.

In the present embodiment, the CATV mobile terminal 6 is operative to communicate with the CATV station 3 or 4 using the local IP assigned by the CATV station 3 or 4. The subscriber station 2 can obtain the local IP assigned by the CATV station 3 or 4 to the CATV mobile terminal 6 when the CATV mobile terminal 6 first moved into the service area of the CATV station 3 or 4 when the subscriber station 2 inquires about the delivery history information to the CATV station 3 or 4 or about the utilization history information to the CATV mobile terminal 6 by way of multicast communication. This leads to the fact that the subscriber station 2 can communicate with the CATV mobile terminal 6 using the same local IP from then on, thereby reducing unnecessary packets caused by the multicast communication. It is needless to mention that the CATV mobile terminal 6 may return to the subscriber station and other CATV stations any data other than the utilization history information.

### INDUSTRIAL APPLICABILITY

The present invention can provide a mobile communication terminal recognizing system, a mobile communication terminal, a relay apparatus, a center apparatus, and a mobile communication terminal recognizing method thereof, which enable a user to receive contents related to the cable television service regardless of whether or not the user moves into a service area other than the service area of the CATV station to which the user has subscribed, as well as are capable of easily identifying the service area where the user is located and accordingly communicating with the user.

The response information is not limited to the utilization history information. The response message may further include position information, vehicle information, subscriber station information, a message, terminal information, information on a station which the user is connected with, and the like. Furthermore, the CATV station, from which the user is currently receiving the CATV service, can be identified on the basis of the relay position identification information contained in the response message.

1. A mobile communication terminal recognizing system, comprising:
a mobile communication terminal mounted on a movable object and capable of establishing a connection with a cable television service line by wireless;
a plurality of relay apparatuses respectively installed in a plurality of service areas, and each of said relay apparatuses being operative to deliver contents concerning a cable television service to said mobile communication terminal moving within each of said service areas; and
a center apparatus for establishing a connection with said mobile communication terminal and said relay apparatuses to ensure that said mobile communication terminal moving within said service area receives said contents from one of said relay apparatuses, and in which
said mobile communication terminal moving within a service area is operative to transmit request information and user information to said relay apparatus installed in said service area by wireless,
said relay apparatus installed in said service area is operative to assign relay position identification information to said mobile communication terminal in response to said request information and user information,
said mobile communication terminal is operative to transmit content request information to said relay apparatus determined in accordance with said relay position identification information by wireless upon receiving said relay position identification information,
said relay apparatus is operative to deliver said contents to said mobile communication terminal and store therein delivery history information indicative of a history of delivering said contents in response to said content request information,
said mobile communication terminal is operative to store therein utilization history information indicative of a history of utilizing said contents,
said center apparatus is operative to inquire to said relay apparatuses about said delivery history information by wireless,
said relay apparatuses are operative to transmit said delivery history information to said center apparatus if stored therein,
said center apparatus is operative to collect and count said delivery history information received from said relay apparatuses and inquire to each of said relay apparatuses about said user information of said mobile communication terminal having logged into in said service area of each of said relay apparatuses, and
said mobile communication terminal is operative to transmit to said center apparatus said relay position identification information assigned thereto within said service area and said utilization history information stored therein in combination with said user information when said center apparatus inquires about said user information of said mobile communication terminal having logged into in said service area.

2. A mobile communication terminal recognizing system as set forth in claim 1, in which
said center apparatus is operative to compare said collected and counted delivery history information with said utilization history information, and perform an accounting process on the basis of the result of the comparison when said mobile communication terminal transmits to said center apparatus said relay position identification information assigned thereto and said utilization history information stored therein in combination with said user information.

3. A mobile communication terminal recognizing system as set forth in claim 1 or claim 2, in which said user information is constituted by personal information stored in an IC (integrated circuit) card or a magnetic card.

4. A mobile communication terminal recognizing system as set forth in any of claims 1 through 3, in which said mobile communication terminal is operative to communicate with each of said relay apparatuses using said relay position identification information assigned thereto by each of said relay apparatuses.

5. A mobile communication terminal mounted on a movable object and capable of establishing a connection with a plurality of relay apparatuses each operative to deliver contents concerning a cable television service by wireless as well as communicating with a center apparatus operative to control said relay apparatuses, said mobile communication terminal comprising:
first transmitting means for transmitting request information and user information to a relay apparatus installed in a service area by wireless;
first receiving means for receiving relay position identification information assigned thereto from said relay apparatus by wireless;
second transmitting means for transmitting content request information to said relay apparatus by wireless upon receiving said relay position identification information by said first receiving means;
second receiving means for receiving said contents delivered from said relay apparatus;
storage means for storing therein utilization history information indicative of a history of utilizing said contents received by said second receiving means, and
third transmitting means for transmitting to said center apparatus said relay position identification information assigned thereto within said service area and said utilization history information stored therein in combination with said user information when said center apparatus inquires about said user information by way of multicast communication.

6. A mobile communication terminal as set forth in claim 5, in which
said user information is constituted by personal information stored in an IC (integrated circuit) card or a magnetic card, and which further comprises:
reading means for reading said user information stored in said IC card.

7. A mobile communication terminal as set forth in claim 6, in which
said mobile communication terminal is operative to communicate with each of said relay apparatuses using said relay position identification information assigned thereto by each of said relay apparatuses.

8. A relay apparatus installed in a service area, for delivering contents concerning a cable television service to a mobile communication terminal under the control of a center apparatus, said relay apparatus comprising:
first receiving means for receiving request information and user information from said mobile communication terminal by wireless;
first transmitting means for transmitting relay position identification information to be assigned to said mobile communication terminal to said mobile communication terminal in response to said request information and user information received by said first receiving means;
second receiving means for receiving content request information from said mobile communication terminal by wireless;
delivering means for delivering said contents to said mobile communication terminal in response to said content request information received by said second receiving means;
storage means for storing therein delivery history information indicative of a history of delivering said contents;
second transmitting means for transmitting said delivery history information stored in said storage means to said center apparatus when said center apparatus inquires about said delivery history information by way of multicast communication; and
third transmitting means for transmitting to said center apparatus said user information of said mobile communication terminal having logged into in said service area when said center apparatus inquires about said user information of said mobile communication terminal having logged into in said service area, by way of multicast communication.

9. A relay apparatus as set forth in claim 8, in which
said relay apparatus is operative to communication with said mobile communication terminal using said relay position identification information assigned to said mobile communication terminal by said relay apparatus in said service area.

10. A center apparatus for controlling a plurality of relay apparatuses respectively installed in a plurality of service areas, and each of said relay apparatuses being operative to deliver contents concerning a cable television service to a mobile communication terminal moving within each of said service areas, said center apparatus comprising:
first transmitting means for inquiring to said relay apparatuses about a delivery history information indicative of a history of delivering said contents by way of multicast communication;
first receiving means for receiving said deliver history information from said relay apparatuses;
collecting and counting means for collecting and counting said delivery history information received from said relay apparatuses;
second transmitting means for inquiring each of said relay apparatuses about user information of said mobile communication terminal having logged into in said service area of each of said relay apparatuses; and
second receiving means for receiving relay position identification information assigned to said mobile communication terminal within said service area and utilization history information indicative of a history of utilizing said contents in combination with said user information from said mobile communication terminal.

11. A center apparatus as set forth in claim 10, further comprising accounting means for comparing said collected and counted delivery history information with said utilization history information, and perform an accounting process on the basis of the result of the comparison when said mobile communication terminal transmits to said center apparatus said relay position identification information assigned thereto and said utilization history information in combination with said user information.

12. A mobile communication terminal recognizing method of recognizing a mobile communication terminal moving within a service area in a system comprising a plurality of relay apparatuses respectively installed in a plurality of service areas, each of said relay apparatuses being operative to deliver contents concerning a cable television service to said mobile communication terminal moving within each of said service areas, a center apparatus for controlling said relay apparatuses to establish a connection with said mobile communication terminal and said relay apparatuses to ensure that said mobile communication terminal is recognized, said method comprising the steps of;
(a) transmitting request information and user information to said relay apparatus installed in said service area by wireless;
(b) transmitting relay position identification information assigned to said mobile communication terminal in response to said request information and user information, by said relay apparatus;
(c) transmitting content request information to said relay apparatus determined in accordance with said relay position identification information by wireless upon receiving said relay position identification information, by said mobile communication terminal;
(d) delivering said contents to said mobile communication terminal and store therein delivery history information indicative of a history of delivering said contents, by said relay apparatus in response to said content request information, by said relay apparatus;
(e) storing therein utilization history information indicative of a history of utilizing said contents, by said mobile communication terminal;
(f) inquiring to said relay apparatuses about said delivery history information by wireless, by said center apparatus;
(g) transmitting said delivery history information to said center apparatus if stored therein, by said relay apparatuses;
(h) collecting and counting said delivery history information and inquiring to each of said relay apparatuses about said user information of said mobile communication terminal having logged into in said service area of each of said relay apparatuses, by said center apparatus; and
(i) transmitting from said mobile communication terminal to said center apparatus said relay position identification information assigned thereto within said service area and said utilization history information stored therein in combination with said user information when inquired about said user information of said mobile communication terminal having logged into in said service area.
